(19) United States
(12) Patent Application Publication
(10) Pub. No.: US 2023/0114009 A1
(43) Pub. Date: Apr. 13, 2023

(54) Information Processing Apparatus and Program Starting Method

(71) Applicant: Hitachi Astemo, Ltd., Hitachinaka-shi, Ibaraki (JP)

(72) Inventors: Nobuyoshi MORITA, Tokyo (JP); Yasuhiro FUJII, Tokyo (JP); Shuhei KANEKO, Tokyo (JP); Teruaki NOMURA, Tokyo (JP)

(21) Appl. No.: 17/796,158

(22) PCT Filed: Jan. 29, 2021
(86) PCT No.: PCT/JP2021/003372

§ 371 Date: Jul. 28, 2022

(30) Foreign Application Priority Data
Feb. 28, 2020 (JP) 2020-033870

(51) Int. Cl. G06F 21/57; G06F 8/65

(52) U.S. Cl. CPC G06F 21/572; G06F 8/65; G06F 2221/033

(57) ABSTRACT

An information processing apparatus that executes a program includes: a storage unit that includes a first region and a second region in which different versions of the same type of program are rewritably stored; and a computation unit that executes the program stored in the storage unit, in which each of the first region and the second region stores the program and up-to-dateness information regarding up-to-dateness of the program, the information processing apparatus determines whether or not to update the storage unit with the program based on the up-to-dateness information received together with the program to be updated, and the information processing apparatus starts the program with the up-to-dateness information indicating higher up-to-dateness among the programs stored in the respective regions.

### CROSS REFERENCE TO RELATED APPLICATIONS

This application claims priority to Japanese Patent Application No. 2020-33870 filed on Feb. 28, 2020, the contents of which are incorporated herein by reference.

### TECHNICAL FIELD

The present invention relates to an information processing apparatus and a control apparatus, and more particularly, to a program starting method.

### BACKGROUND ART

As a recovery measure at the time of failure of program update, a program update technology for updating only a program in one of two storage regions capable of holding the same type of program for a device including the two storage regions has been studied. Specifically, a memory region including a starting region where the program is executed and a standby region where the program is not executed is provided, the program stored in the standby region is updated, and starting information is updated in such a way as to switch the starting region and the standby region after the program update is completed. As a result, in a case where the program update fails, there is no influence on the starting region that is not the update target.

In addition, in updating the program, it is preferable to verify that an update program is genuine, that is, the update program has not been tampered with illegally. For example, PTL 1 (JP 2017-21434 A) discloses an information processing apparatus in which a first verification unit verifies validity of update software and a version number, a roll-back detection unit compares the version number of the update software with a version number of current software held by a counter unit, and detects whether or not a version of the update software is new, an update unit updates the software by using the update software in a case where it is determined that the version of the update software is new, a second verification unit verifies whether or not the update of the software is successful, and a version management unit increases the version number held by the counter unit until the version number matches the version number of the update software only in a case where the second verification unit succeeds in updating the software. According to such a technology of PTL 1, it is possible to update the current program to the latest program that has not been tampered with.

### SUMMARY OF INVENTION

### Technical Problem

In the technology described in PTL 1, the program is verified at the time of update, but there is a chance of being affected by a cyberattack even after the program update, and there is a possibility that the program is tampered with illegally due to the vulnerability.

Secure Boot has become widespread as a technology for verifying the integrity of a program at the time of starting the program. However, since starting region information changes due to the update of the program, and the starting region of the information processing apparatus cannot be grasped in advance, it cannot be verified that the starting region information has not been tampered with. It is possible to grasp the starting region in advance by checking the current starting region of the information processing apparatus. However, in a case where the number of information processing apparatuses to be checked is several millions, the program update work requires preliminary management of each information processing apparatus, and the operation load increases, which is practically undesirable.

The present invention has been made in view of the above problems, and an object of the present invention is to guarantee that a program to be started and starting region information have not been tampered with while ensuring that the program is up-to-date when an information processing apparatus is started, and to reduce an operation load on a worker who performs program update.

### Solution to Problem

A typical example of the invention disclosed in the present application is as follows. That is, an information processing apparatus that executes a program includes: a storage unit that includes a first region and a second region in which different versions of the same type of program are rewritably stored; and a computation unit that executes the program stored in the storage unit, in which each of the first region and the second region stores the program and up-to-dateness information regarding up-to-dateness of the program, the information processing apparatus determines whether or not to update the storage unit with the program based on the up-to-dateness information received together with the program to be updated, and the information processing apparatus starts the program with the up-to-dateness information indicating higher up-to-dateness among the programs stored in the respective regions.

### Advantageous Effects of Invention

According to the present invention, it is possible to ensure the up-to-dateness of the program by the up-to-dateness information, and it is possible to select a region in which the up-to-date program is stored at the time of starting and start the program. Problems, configurations, and effects other than those described above will become apparent by the following description of embodiments.

### BRIEF DESCRIPTION OF DRAWINGS

FIG. 1 is a diagram illustrating a configuration of an information processing apparatus according to an embodiment of the present invention.

FIG. 2 is a diagram illustrating a schematic processing flow of program update in the information processing apparatus according to the embodiment of the present invention.

FIG. 3 is a diagram illustrating a schematic processing flow of program starting in the information processing apparatus according to the embodiment of the present invention.

FIG. 4 is a diagram illustrating a data structure of update program-related data according to the embodiment of the present invention.

FIG. 5 is a diagram illustrating a data structure according to the embodiment of the present invention.

FIG. 6 is a diagram illustrating an outline of a storage region according to the embodiment of the present invention.

FIG. 7 is a diagram illustrating a data structure of verification target range information according to the embodiment of the present invention.

FIG. 8 is a diagram illustrating a data structure of an update program package according to the embodiment of the present invention.

### DESCRIPTION OF EMBODIMENTS

Hereinafter, an embodiment of the present invention will be described in detail with reference to the drawings.

An example of a method of starting a program for an information processing apparatus (for example, an electric control unit that controls a vehicle) connected to an in-vehicle network will be described as an embodiment of the present invention. However, the technical idea of the present invention is not limited to this example. For example, the present invention can be applied to an information processing apparatus other than a vehicle control apparatus (for example, a healthcare device) as long as the information processing apparatus has a two-plane configuration in which a starting region and a standby region are provided and updates a program, instead of the in-vehicle control apparatus (ECU).

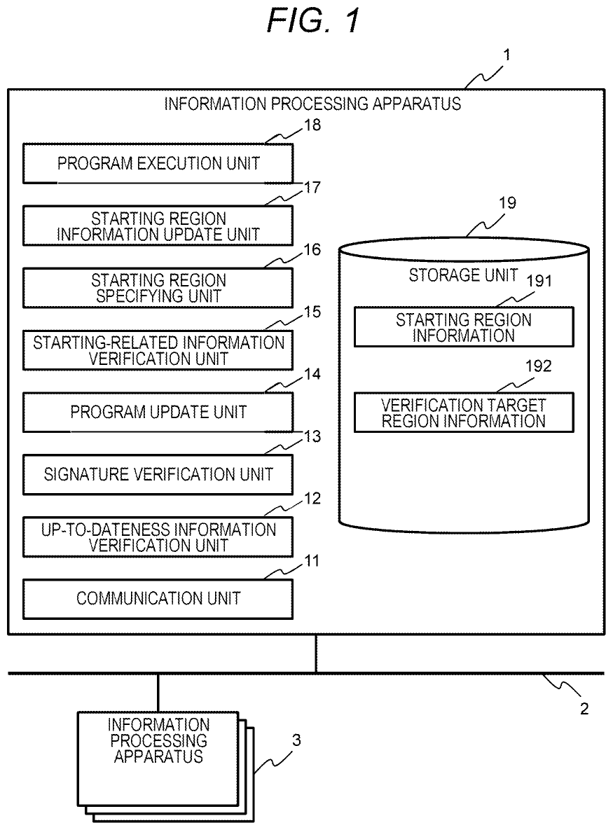

FIG. 1 is a diagram illustrating a configuration of an information processing apparatus according to the embodiment of the present invention. An information processing apparatus 1 is connected to another information processing apparatus 3 via a communication bus 2. However, the communication bus 2 may physically include a plurality of communication buses, and the standards of these communication buses may be the same or different. As the standards of these communication buses, CAN (registered trademark), LIN (registered trademark), FlexRay (registered trademark), Ethernet (registered trademark), and the like can be used. Hereinafter, the information processing apparatus 1 will be described, but the information processing apparatus 3 has the same configuration.

The information processing apparatus 1 includes a CPU (not illustrated), a ROM (not illustrated), and a RAM (not illustrated), and implements the following functions by the CPU loading a program stored in the ROM to the RAM and executing the program. That is, the information processing apparatus 1 includes, as the functions thereof, an up-to-dateness information verification unit 12, an expected verification value verification unit 13, a program update unit 14, a starting-related information verification unit 15, a starting region specifying unit 16, a starting region information update unit 17, and a program execution unit 18. Furthermore, the information processing apparatus 1 includes a storage unit 19 that is a nonvolatile storage device, and a communication unit 11 that is a communication interface and performs computation necessary for communication.

The communication unit 11 receives a message transmitted from another information processing apparatus 3 via the communication bus 2, and transmits the message to another information processing apparatus 3 via the communication bus 2. As described above, the communication bus 2 may physically include a plurality of communication buses. The information processing apparatus 1 transmits and receives information necessary for program update by using the communication unit 11. The up-to-dateness information verification unit 12 compares up-to-dateness information held by the information processing apparatus 1 with up-to-dateness information included in update program-related data, and determines which is up-to-dateness information indicating higher up-to-dateness. The expected verification value verification unit 13 verifies whether or not the update program-related data has been tampered with. The program update unit 14 updates the standby region with the update program-related data. The starting-related information verification unit 15 verifies whether or not predetermined starting-related information including a program that is a verification target, the up-to-dateness information, and the like has been tampered with. The starting region specifying unit 16 compares the pieces of up-to-date information of the regions with each other and specifies, as the starting region, a region holding the up-to-date information indicating higher up-to-dateness. The starting region information update unit 17 updates the region specified by the starting region specifying unit 16 as starting region information 191 to be described later. In a case where the starting-related information verification unit 15 determines that the starting region information 191 has not been tampered with, the program execution unit 18 executes the program of the starting region.

The storage unit 19 stores the starting region information 191 indicating a storage region in which a program to be executed at the time of starting is held, and verification target range information 192 indicating a verification target range of the starting-related information verification unit 15.

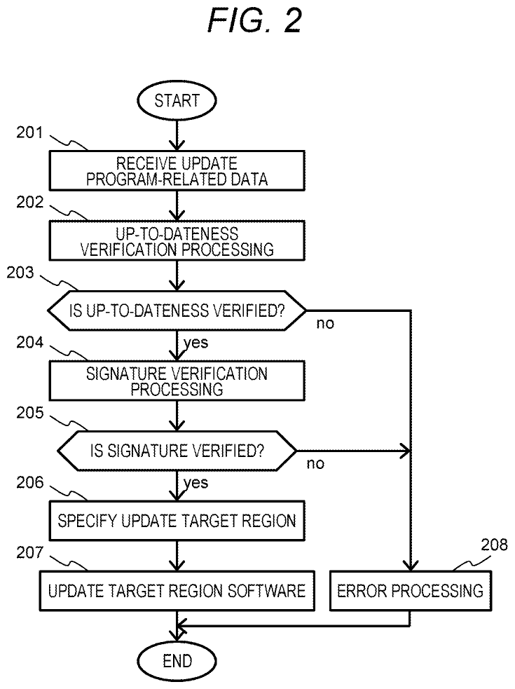

FIG. 2 is a flowchart of processing in which the information processing apparatus 1 updates the program. An execution subject of each step described below is the CPU (not illustrated) of the information processing apparatus 1.

In Step 201, the information processing apparatus 1 receives the update program-related data by using the communication unit 11.

FIG. 4 illustrates an example of update program-related data 401 received by the information processing apparatus 1 in Step 201. A program of a control apparatus 4 is transmitted from a server in a package in the form of the update program-related data 401 illustrated in the drawing. The update program-related data 401 includes a program 402 executed by the information processing apparatus 1, up-to-dateness information 403 associated with the program 402, and an expected verification value 404 that is referred to when the expected verification value verification unit 13 verifies whether or not the program 402 has been tampered with. For example, information on a date and time when a creator or a creation tool of the update program-related data 401 creates the update program-related data 401 is the up-to-dateness information 403, and a signature generation result using the program 402 and the up-to-dateness information 403 is the expected verification value 404. Note that the expected verification value 404 may be a signature value generated using a public key encryption technology such as DSA, ECDSA, or RSA, may be a value of a message authentication code (MAC) generated using a common key encryption technology such as AES-CMAC, or may be a hash or a checksum.

In Step 202, the up-to-dateness information verification unit 12 acquires the up-to-dateness information 403 from the update program-related data 401 received in Step 201, and compares the acquired up-to-dateness information 403 with the up-to-dateness information held by the information processing apparatus 1.

In Step 203, in a case where a result of the comparison in Step 202 indicates that the up-to-dateness information 403 acquired from the update program-related data 401 received in Step 201 indicates higher up-to-dateness, the up-to-dateness information verification unit 12 proceeds to Step 204, otherwise, the up-to-dateness information verification unit proceeds to Step 208. For example, in a case of using the information on the date and time as the up-to-dateness information, in a case where the value of the up-to-dateness information 403 acquired from the update program-related data 401 is “Dec. 1, 2019, 12:45:52” and the up-to-dateness information held by the information processing apparatus 1 is “Nov. 20, 2019, 20:30:35”, it is determined that the received up-to-dateness information 403 indicates higher up-to-dateness. In addition, a value for which counting or one-time use is guaranteed and which is incremented may be used as the up-to-dateness information, and in this case, it is determined that a larger value indicates higher up-to-dateness.

In Step 204, the expected verification value verification unit 13 calculates an expected verification value with a predetermined expected verification value verification algorithm by using the program 402 and the up-to-dateness information 403 included in the update program-related data 401 received in Step 201, and verifies whether or not the calculated expected verification value matches the expected verification value 404 included in the update program-related data 401.

In Step 205, the expected verification value verification unit 13 proceeds to Step 206 in a case where the expected verification value calculated in Step 204 and the expected verification value 404 match each other, and the expected verification value verification unit 13 proceeds to Step 208 in a case where the expected verification value and the expected verification value 404 do not match each other.

In Step 206, the starting region specifying unit 16 specifies the current starting region by referring to the starting region information 191, and specifies the standby region as an update target region in which the program is to be updated.

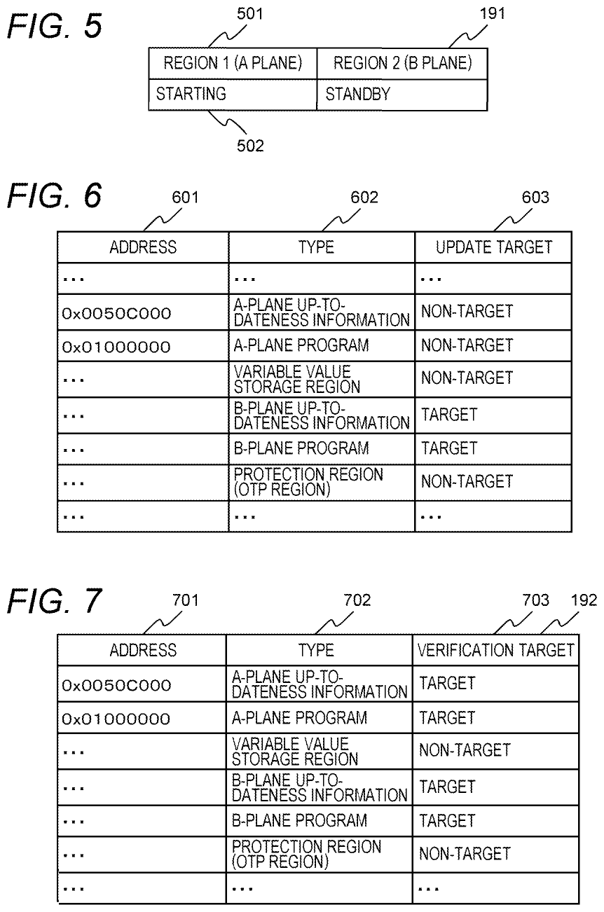

FIG. 5 illustrates an example of the starting region information 191 which is referred to by the starting region specifying unit 16 to specify whether or not each region of the storage unit 19 is the starting region in Step 206. The starting region information 191 includes a storage region 501 of the storage unit 19 corresponding to an apparatus whose program is to be updated, and an identifier 502 indicating the starting region and the standby region. For example, in a case where a region 1 (A plane) is “starting” and a region 2 (B plane) is “standby”, the current starting region is the region 1 (A plane). Note that information indicating whether each region is the starting region or the standby region may be registered in the identifier 502 as illustrated in the drawing, information indicating which one of the A plane and the B plane of each region is the starting region may be registered in the identifier 502, or information indicating which one of the A plane and the B plane of each region is the standby region may be registered in the identifier 502.

In Step 207, the program update unit 14 updates the update target region specified in Step 206 by using the update program-related data 401. For example, in a case of updating the region 2 (B plane) specified as the update target region in Step 206, the program update unit 14 rewrites a memory related to the region 2 (B plane) corresponding to an address 601 with new update program-related data.

FIG. 6 illustrates an example of the storage region that is a program update target in Step 207. The address 601 indicates an address value assigned to the head of the storage region, a type 602 indicates the type of the storage region starting from the address 601, and an update target 603 indicates whether or not the storage region starting from the address 601 is an update target. For example, in a case of updating the region 2 (B plane) specified as the update target region in Step 206, the program update unit 14 sets a region starting from the address 601 related to the B plane in the type 602 as the update target, and rewrites the region starting from the address with the update program-related data.

In Step 208, in a case where the up-to-dateness is not guaranteed in Step 203 or in a case where the signature verification fails in Step 205, the information processing apparatus 1 performs predetermined error processing.

With the above steps, the program of the information processing apparatus 1 connected to the in-vehicle network can be updated.

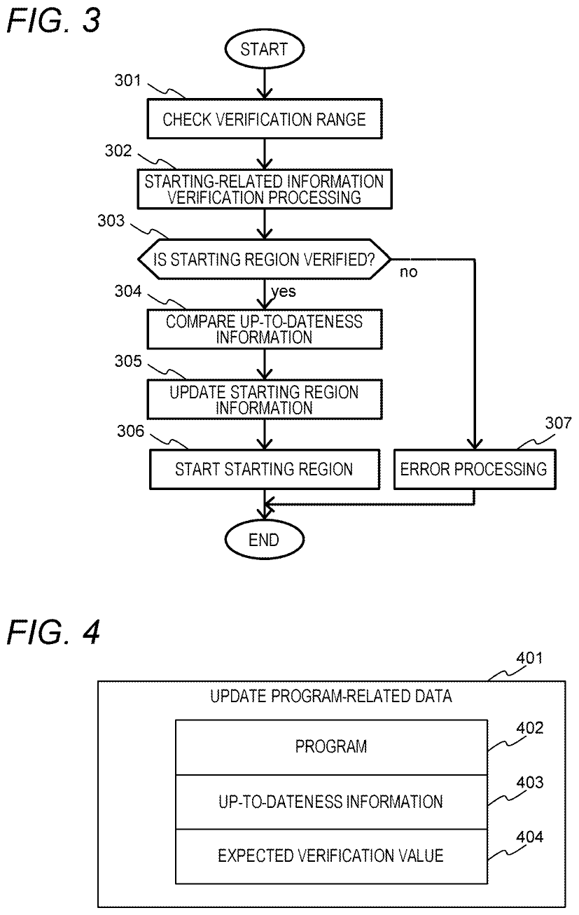

FIG. 3 is a flowchart illustrating processing in which the information processing apparatus 1 starts the program. An execution subject of each step described below is the CPU (not illustrated) of the information processing apparatus 1.

In Step 301, the starting-related information verification unit 15 specifies a target of verification of tampering at the time of starting by referring to the verification target range information 192. In particular, in addition to the program to be started, the up-to-dateness of the region in which the program is stored is also a verification target.

FIG. 7 illustrates an example of the verification target range information 192 which is referred to by the starting-related information verification unit 15 to specify the verification target range in Step 301. The verification target range information 192 includes an address 701 indicating an address assigned to the head of the storage region, a type 702 indicating the type of the storage region starting from the address, and a verification target 703 indicating whether or not the storage region starting from the address 701 is a verification target. For example, the starting-related information verification unit 15 sets, as the verification target, a storage region in a predetermined range after the address 701 “0x00500000” for which the verification target 703 is “target”. Note that the verification target range of each storage region may be determined in advance, or may be dynamically changed based on a predetermined procedure. For example, a range actually used by the program may be set as the verification target range.

In Step 302, the starting-related information verification unit 15 verifies whether or not the verification target specified in Step 301 has been tampered with. In a case where the expected verification value calculated from data stored in the verification target region matches the expected verification value 404 written in the storage region in Step 207, it can be determined that the verification target region has not been tampered with. The expected verification value used in the verification processing may be an MAC value generated using a common key encryption technology such as AES-CMAC, a signature value generated using a public key encryption technology such as ECDSA or RSA, or a hash or a checksum.

In Step 303, the starting-related information verification unit 15 proceeds to Step 304 in a case where a result of the verification in Step 302 indicates that the expected verification values match each other, and proceeds to Step 307 in a case where the result of the verification in Step 302 indicates that the expected verification values do not match each other.

In Step 304, the starting region specifying unit 16 acquires the up-to-dateness information 403 stored in each storage region and specifies a region having the highest up-to-dateness.

In Step 305, the starting region information update unit 17 updates the starting region information 191 by setting the storage region 501 that holds the latest up-to-dateness information 403 indicating the highest up-to-dateness specified in Step 304 as the “starting region” and setting the storage region 501 that does not hold the latest up-to-dateness information 403 indicating the highest up-to-dateness as the “standby region”.

In Step 306, the program execution unit 18 executes the program stored in the storage region determined as the starting region in Step 305.

In Step 307, in a case where the verification result does not indicate that the expected verification values match each other in Step 303, the information processing apparatus 1 executes predetermined error processing.

Note that, although the starting region is verified (302 and 303) before comparing the up-to-dateness information (304) and updating the starting region information 191 (305) in the flowchart illustrated in FIG. 3, the starting region may also be verified (302 and 303) after comparing the up-to-dateness information (304) and updating the starting region information 191 (305). That is, the pieces of processing of Steps 302 and 303 are performed between Steps 305 and 306. In this way, the verification range is narrowed, as a result of which, the program can be started at a high speed. Meanwhile, in the embodiment illustrated in FIG. 3, the standby region is also verified together with the starting region, but in the above-described modification, the standby region is not verified and remains as an unverified region. Therefore, the program in the unverified region may be locked so as not to be started.

With the above steps, the program of the information processing apparatus 1 connected to the in-vehicle network can be safely started.

In the present embodiment, a case where the same expected verification value is used as the expected verification value used for verification at the time of updating the program and the expected verification value used for verification at the time of starting the program has been described. On the other hand, in Step 207, in a case where the verification range targeted by the expected verification value 404 included in the update program-related data 401 does not match the range of verification of the starting-related information performed by the information processing apparatus at the time of starting, both the expected verification value for program update and the expected verification value for program starting may be included in the update program-related data 401. Specifically, in the verification processing at the time of updating the program in Step 204, an expected verification value 804 for program update is used as the expected verification value, and in the verification processing at the time of starting the program in Step 302, an expected verification value 807 for starting is used as the expected verification value.

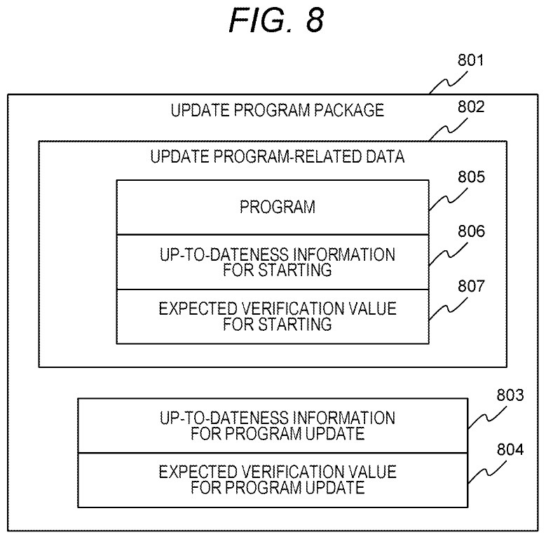

FIG. 8 illustrates an example of an update program package 801 in a case where the expected verification value for program update and the expected verification value for program starting are different.

The update program package 801 includes update program-related data 802, up-to-dateness information 803 for program update, and the expected verification value 804 for program update. The update program-related data 802 includes a program 805, up-to-dateness information 806 for starting, and an expected verification value 807 for starting. The update program-related data 802 is used by the program update unit 14 to rewrite the standby region in Step 207. The up-to-dateness information 803 for program update is generated at the time of creating the update program package 801, and is used by the up-to-dateness information verification unit 12 to verify the up-to-dateness information in Step 202. The expected verification value 804 for program update is generated at the time of creating the update program package 801, and is used by the expected verification value verification unit 13 to verify the update program in Step 204. The up-to-dateness information 806 for starting is generated at the time of creating the program 805, and is referred to by the starting region specifying unit 16 to specify a region holding the up-to-dateness information indicating higher up-to-dateness in Step 303. The expected verification value 807 for starting is generated at the time of creating the program 805, and is used as an expected verification value for verifying whether or not a region to be verified has been tampered with by the starting-related information verification unit 15 in Step 302.

As described above, according to Embodiment 1 of the present invention, it is possible to verify tampering of the starting region information 191 indicating the starting region, in addition to the program to be executed, at the time of starting the program. In addition, a worker who performs program update only needs to give the up-to-dateness information at the time of generation of the update program-related data without being conscious of the up-to-dateness information held by the information processing apparatus 1. As a result, the safety of the information processing apparatus 1 can be secured every time the information processing apparatus 1 is started, and the operation load of the worker who performs program update can be reduced.

As described above, the information processing apparatus 1 according to the embodiment of the present invention includes the storage unit 19 that includes a first region and a second region in which different versions of the same type of program are rewritably stored, and a computation unit (CPU) that executes the program stored in the storage unit 19, in which each of the first region and the second region stores the program and up-to-dateness information regarding up-to-dateness of the program, the information processing apparatus 1 determines whether or not to update the storage unit 19 with the program based on the up-to-dateness information received together with the program to be updated, and the information processing apparatus 1 starts the program with the up-to-dateness information indicating higher up-to-dateness among the programs stored in a plurality of regions. Therefore, the version of the program can be up-to-date by the up-to-dateness information. That is, it is possible to select a region in which the up-to-date program is stored at the time of starting, and start the program.

Each of the first region and the second region further stores an expected verification value for verifying the program stored in each region and the up-to-dateness information, and the information processing apparatus 1 verifies the program and the up-to-dateness information of the program by using the expected verification value at the time of starting the program, and makes the program startable when the verification is successful. Therefore, it is possible to guarantee that the up-to-dateness information and the program to be started have not been tampered with.

One of the first region and the second region is a starting region in which the program is executed, and the other of the first region and the second region is a standby region in which the program is updated. Therefore, it is possible to update the program without stopping the information processing apparatus 1.

The program is included in a package and transmitted to the information processing apparatus 1, and the package includes the up-to-dateness information generated at the time of creating the package. Therefore, it is possible to determine the up-to-dateness for each package.

The program is included in a package and transmitted to the information processing apparatus 1, the package includes the up-to-dateness information generated at the time of creating the package or the program included in the package, and an expected verification value for verifying the program and the up-to-dateness information, and the information processing apparatus 1 verifies the up-to-dateness information included in the package by using the expected verification value at the time of updating and starting the program. Therefore, it is possible to determine whether or not the program has been tampered with by using one expected verification value at the time of updating the program and at the time of starting the program.

The program is included in a package and transmitted to the information processing apparatus 1, the package includes up-to-dateness information for update generated at the time of creating the package and up-to-dateness information for starting generated at the time of creating the program included in the package, and the information processing apparatus 1 verifies the up-to-dateness information for update at the time of updating the program and verifies the up-to-dateness information for starting at the time of starting the program. Therefore, even if the range of the program to be updated and the range of the program to be started are different, it is possible to determine whether or not the program has been tampered with at the time of updating the program and at the time of starting the program.

Note that the present invention is not limited to the above-described embodiments, but includes various modifications and equivalent configurations within the scope of the appended claims. For example, the above-described embodiments have been described in detail in order to explain the present invention in an easy-to-understand manner, and the present invention is not necessarily limited to those having all the configurations described. Further, a part of the configuration of one embodiment may be replaced with the configuration of another embodiment. In addition, the configuration of another embodiment may be added to the configuration of one embodiment. In addition, a part of the configuration of each embodiment may be added with another configuration, may be deleted, and may be replaced with another configuration.

Further, a part of, or the entirety of the respective configurations, functions, processing units, processing means, and the like described above may be implemented by hardware, for example, may be designed as an integrated circuit, or may be implemented by software for a processor interpreting and executing programs for implementing the respective functions.

Information such as a program, a table, and a file for implementing each function can be stored in a storage device such as a memory, a hard disk, or a solid state drive (SSD), or a recording medium such as an IC card, an SD card, a DVD, or a BD.

In addition, the control lines and information lines indicate those considered necessary for explanation, and do not necessarily indicate all the control lines and information lines necessary for implementation. In actual implementation, it may be considered that almost all configurations are interconnected.

1. An information processing apparatus that executes a program, the information processing apparatus comprising:
a storage unit that includes a first region and a second region in which different versions of the same type of program are rewritably stored; and
a computation unit that executes the program stored in the storage unit,
wherein each of the first region and the second region stores the program and up-to-dateness information regarding up-to-dateness of the program,
the information processing apparatus determines whether or not to update the storage unit with the program based on the up-to-dateness information received together with the program to be updated, and
the information processing apparatus starts the program with the up-to-dateness information indicating higher up-to-dateness among the programs stored in the respective regions.

2. The information processing apparatus according to claim 1, wherein each of the first region and the second region further stores an expected verification value for verifying the program stored in each region and the up-to-dateness information, and
the information processing apparatus verifies the program and the up-to-dateness information of the program by using the expected verification value at the time of starting the program, and makes the program startable when the verification is successful.

3. The information processing apparatus according to claim 1, wherein one of the first region and the second region is a starting region in which the program is executed, and the other of the first region and the second region is a standby region in which the program is updated.

4. The information processing apparatus according to claim 1, wherein the program is included in a package and transmitted to the information processing apparatus, and
the package includes the up-to-dateness information generated at the time of creating the package.

5. The information processing apparatus according to claim 2, wherein the program is included in a package and transmitted to the information processing apparatus,
the package includes the up-to-dateness information generated at the time of creating the package or the program included in the package, and the expected verification value for verifying the program and the up-to-dateness information, and
the information processing apparatus verifies the up-to-dateness information included in the package by using the expected verification value at the time of updating and starting the program.

6. The information processing apparatus according to claim 2, wherein the program is included in a package and transmitted to the information processing apparatus,
the package includes up-to-dateness information for update generated at the time of creating the package and up-to-dateness information for starting generated at the time of creating the program included in the package, and
the information processing apparatus verifies the up-to-dateness information for update at the time of updating the program and verifies the up-to-dateness information for starting at the time of starting the program.

7. A program starting method for updating a program of an information processing apparatus that executes the program, wherein the information processing apparatus includes:
a storage unit that includes a first region and a second region in which different versions of the same type of program are rewritably stored; and
a computation unit that executes the program stored in the storage unit,
each of the first region and the second region stores the program and up-to-dateness information regarding up-to-dateness of the program, and
the program starting method comprises:
determining, by the information processing apparatus, whether or not to update the storage unit with the program based on the up-to-dateness information received together with the program to be updated; and
starting, by the information processing apparatus, the program with the up-to-dateness information indicating higher up-to-dateness among the programs stored in the respective regions.
